(19) United States
(12) Patent Application Publication
(10) Pub. No.: US 2021/0221417 A1
(43) Pub. Date: Jul. 22, 2021

(54) COLLAPSIBLE BAG CART

(71) Applicant: Angelia Cazares, Fort Worth, TX (US)

(72) Inventor: Angelia Cazares, Fort Worth, TX (US)

(21) Appl. No.: 16/747,214

(22) Filed: Jan. 20, 2020

(51) Int. Cl. B62B 3/02; B62B 3/00; B62B 3/04; B62B 3/10; B62B 5/06

(52) U.S. Cl. CPC B62B 3/022; B62B 3/005; B62B 3/04; B62B 3/106; B62B 2206/006; B62B 2202/26; B62B 2205/006; B62B 2205/32; B62B 5/06

(57) ABSTRACT

A collapsible bag cart for transporting bags including a shopping bag cart assembly. The shopping bag cart assembly has a base, a plurality of wheels, a first end frame, a second end frame, a hanger shelf, and a plurality of bag hanging mounts. The base has a front end and a rear end. The plurality of wheels is rotatably coupled and extending downwardly from the base. The first end frame is removably attached and extending upwardly from the rear end of the base. The second end frame is removably attached and extending upwardly from the front end of the base. The hanger shelf is removably attached and extending between the first and second end frames. The hanger shelf is positioned adjacent to an apex of each of the first and second end frames. The plurality of bag hanging mounts is attached and extending upwardly from the hanger shelf.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to carts and more particularly pertains to a new collapsible bag cart device for transporting bags. When shopping at a distant location, particularly when a vehicle or other transport is unavailable, a collapsible bag cart may be useful in making the journey easier and more productive by allowing for increased transport volume and reduced physical fatigue. Ideally the personal cart would be configured to carry a variety of bag types and collapsible to allow for ease of transport to the store.

### (2) Description of Related Art Including Information Disclosed Under 37 CFR 1.97 and 1.98

The prior art relates to carts, specifically, carts used to transport shopping bags during and after shopping in a store.

### BRIEF SUMMARY OF THE INVENTION

An embodiment of the disclosure meets the needs presented above by generally comprising a shopping bag cart assembly. The shopping bag cart assembly has a base, a plurality of wheels, a first end frame, a second end frame, a hanger shelf, and a plurality of bag hanging mounts. The base has a front end and a rear end. The plurality of wheels is rotatably coupled to and extends downwardly from the base. The first end frame is removably attached to and extends upwardly from the rear end of the base. The second end frame is removably attached to and extends upwardly from the front end of the base. The hanger shelf is removably attached to and extends between the first and second end frames. The hanger shelf is positioned adjacent to an apex of each of the first and second end frames. The plurality of bag hanging mounts is attached to and extend upwardly from the hanger shelf.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front isometric view of a collapsible bag cart according to an embodiment of the disclosure.

FIG. 2 is a left side view of an embodiment of the disclosure showing the vertical and horizontal relationship of the components.

FIG. 3 is a top rear isometric view from of an embodiment of the disclosure.

FIG. 4 is an exploded view of the components of a collapsible bag cart that may be attached to the base in an embodiment of the disclosure.

FIG. 5 is an exploded view of the components of a collapsible bag cart as they are orientated to each other in an embodiment of the disclosure.

FIG. 6 is a top front isometric view illustrating the storage configuration of an embodiment of the disclosure.

FIG. 7 is a top front isometric view of an alternative embodiment of the disclosure for transporting items without use of the second end frame, middle shelf, or hanger shelf.

FIG. 8 is a top front isometric view of an alternative embodiment of the disclosure for transporting items without use of the middle shelf.

### DETAILED DESCRIPTION OF THE INVENTION

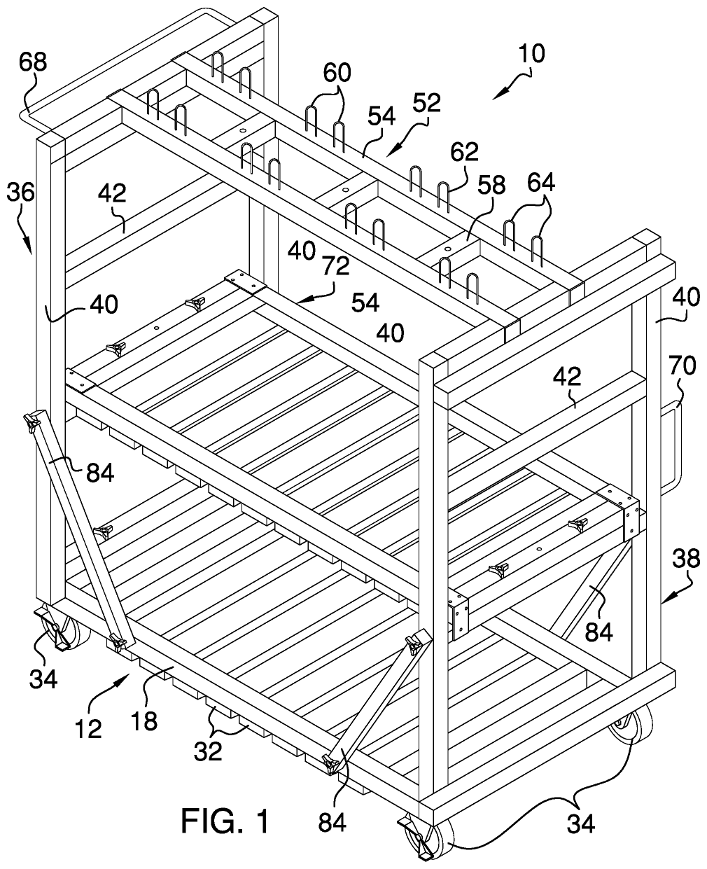

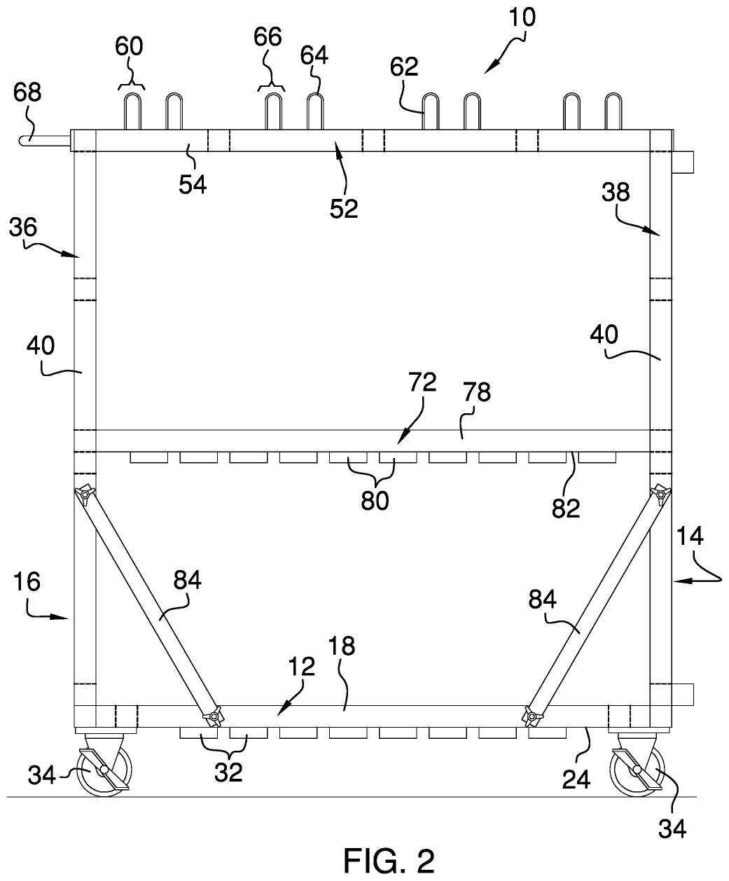

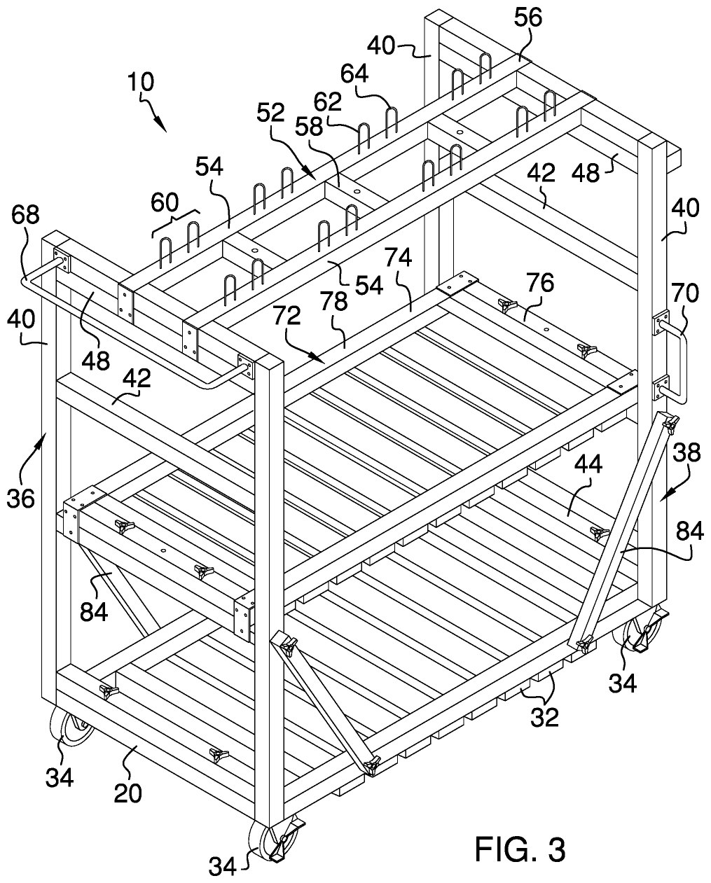

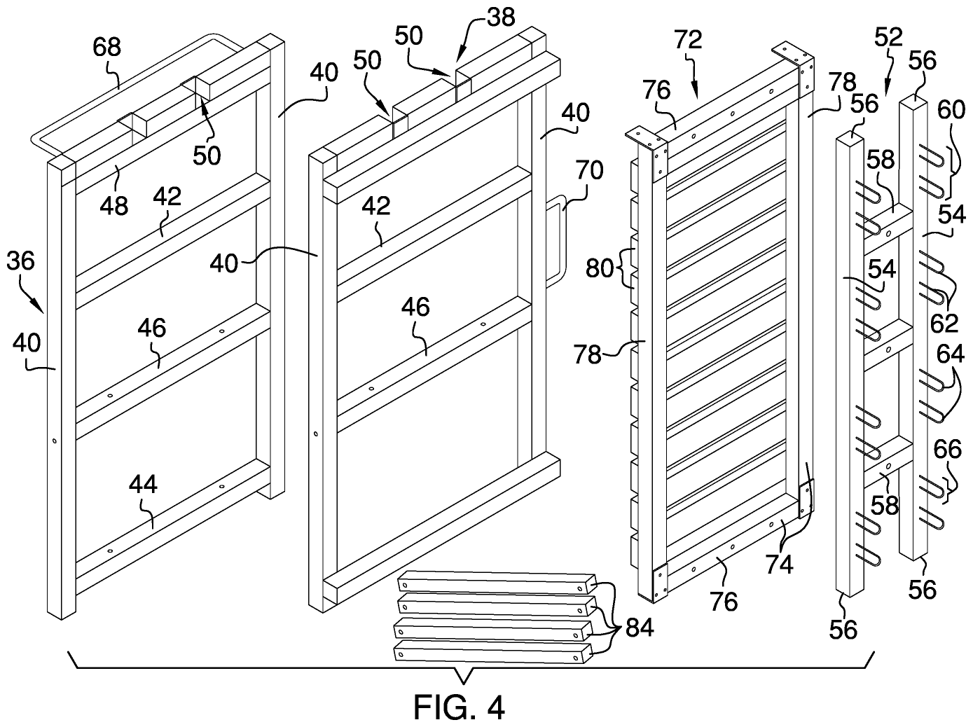

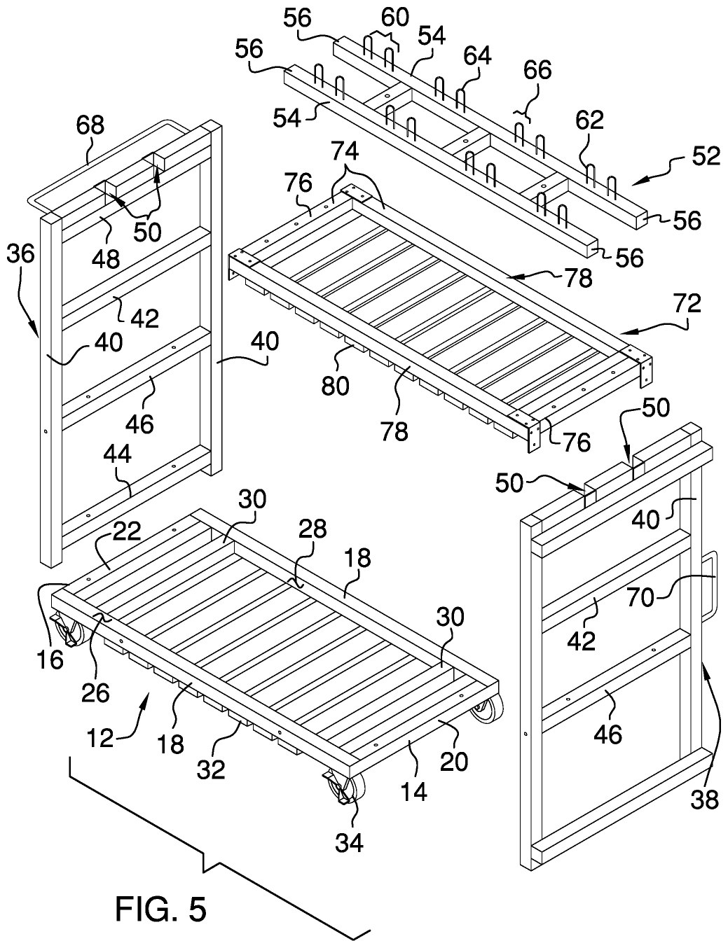

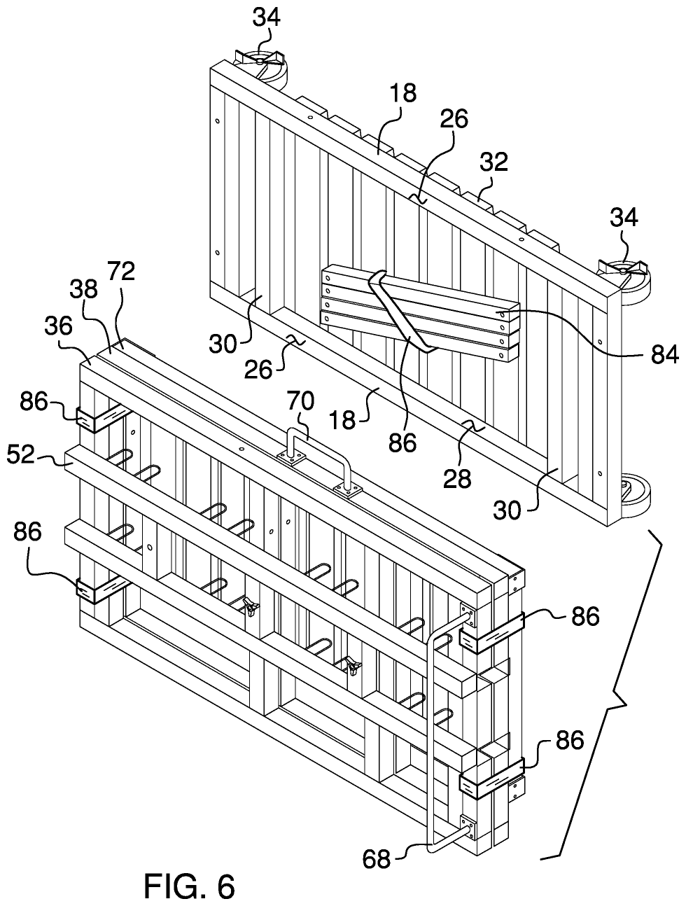

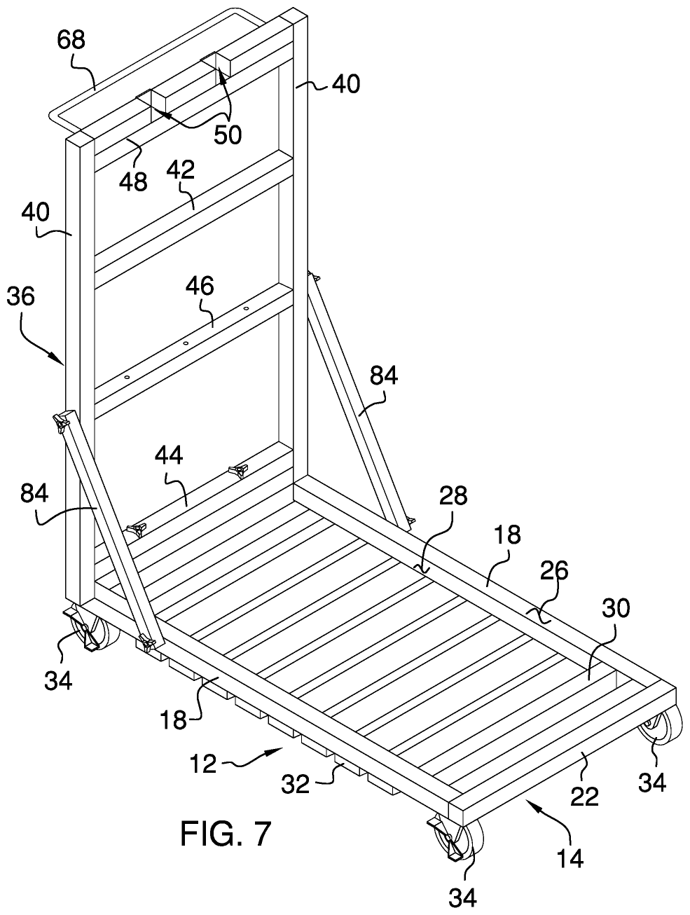

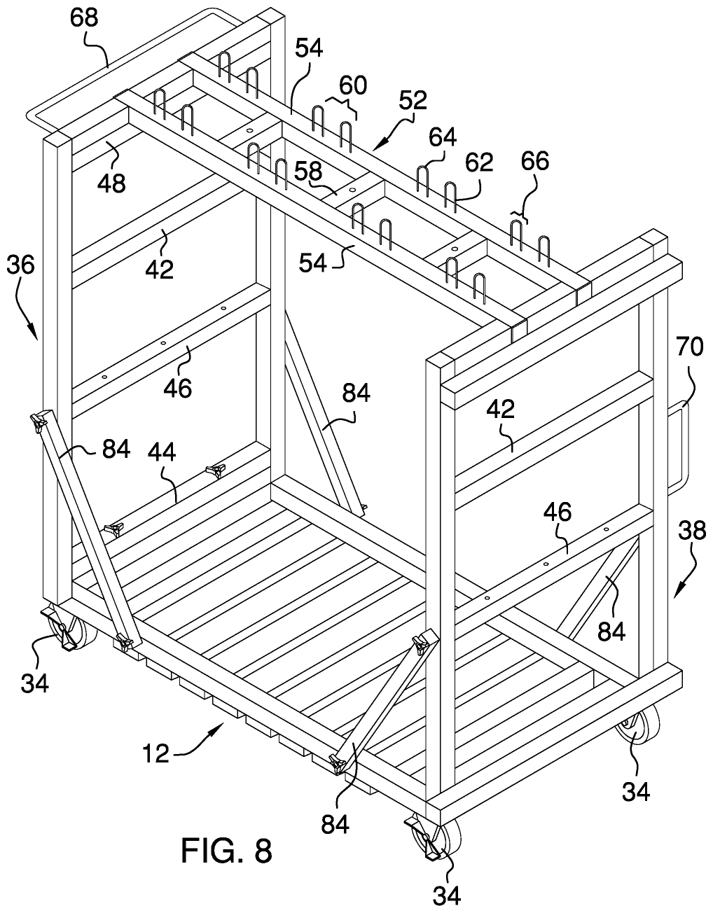

With reference now to the drawings, and in particular to FIGS. 1 through 8 thereof, a new cart embodying the principles and concepts of an embodiment of the disclosure and generally designated by the reference numeral 10 will be described.

As best illustrated in FIGS. 1 through 8, the collapsible bag cart 10 generally comprises a base 12 with a front end 14 and a rear end 16. The base has a pair of longitudinal members 18. Each longitudinal member 18 has a first end 20, a second end 22, a bottom side 24 and a top side 26. Each longitudinal member 18 also has an interior face 28 wherein the interior faces 28 of the longitudinal members 18 face each other. The first ends 20 correspond to the rear end 16. A plurality of cross members 30 are attached to and extends between the interior faces 28 of the longitudinal members 18. One of the cross members 30 is positioned adjacent to the first ends 20 and one of the cross members 30 is positioned adjacent to the second ends 22. A plurality of planks 32 is attached to and extends between the longitudinal members 18. Each of the planks 32 is attached to the bottom sides 24 of the longitudinal members 18. The planks 32 are spaced from each other a distance of between 0.5 inches and 3.0 inches.

A plurality of wheels 34 is rotatably coupled to and extends downwardly from the base 12. The wheels 34 may be lockable or rotatably limited to improve control of the collapsible bag cart 10.

A first end frame 36 is removably attached to and extends upwardly from the rear end 16 of the base 12. A second end frame 38 is removably attached to and extends upwardly from the front end 14 of the base 12. The first 36 and second 38 end frames each have a pair of vertical members 40 each with a height between 3.0 and 6.0 feet. A plurality of cross-beams 42 extends between and is attached to the vertical members 40. The plurality of cross-beams 42 includes a bottom cross-beam 44, a middle cross-beam 46, and a top cross-beam 48. The bottom cross-beam 44 abuts the base 12. The top cross-beam 48 has a pair of spaced receivers 50 extending therein.

A hanger shelf 52 is removably attached to and extends between the first 36 and second 38 end frames. The hanger shelf 52 is positioned adjacent to an apex of each of the first 36 and second 38 end frames. The hanger shelf 52 includes a pair of support beams 54 each having a pair of free ends 56. Each of the receivers 50 are configured to removably receive one of the free ends 56. The hanger shelf 52 further includes at least one brace 58 extending between and attached to the support beams 54.

A plurality of bag hanging mounts 60 is provided. Each of the support beams 54 has at least five of the bag hanging mounts 60 attached thereto. The bag hanging mounts 60 are spaced from each other and extend upwardly from a corresponding one of the support beams 54. Each of the bag hanging mounts 60 has a pair of legs 62 and a central member 64 attached to and extending between the legs 62. Each of the central members 64 each have a top surface 66 with a convexly arcuate shape. The convexly arcuate shape helps to reduce the difficulty of hanging items on the bag hanging mounts 60 and to prevent potential damage to the handles hung on the bag hanging mounts 60.

A push handle 68 is attached to the first end frame 36. The push handle 68 is positioned adjacent to the top cross-beam 48 and extends rearwardly therefrom. The push handle 68 is the primary control method of the collapsible bag cart 10 allowing letting the user steer and propel the rear end 16 of the collapsible bag cart 10 during use. A transport handle 70 is attached to one of the vertical members 40 of the second end frame 38. The transport handle 70 extends laterally away from the second end frame 38. The transport handle 70 provides secondary control of the collapsible bag cart 10 during use by allowing maneuvering of the front end 14. The transport handle 70 is primarily used to carry a portion of the collapsible bag cart 10 during storage and transport.

A middle shelf 72 is removably attached to and extends between the first 36 and second 38 end frames. The middle shelf 72 is vertically disposed between the base 12 and the hanger shelf 52. The middle shelf has an outer frame 74 having a pair of end members 76. Each of the middle cross-beams 46 is removably attached to one of the end members 76. A pair of side members 78 extends between and is attached to the end members 76. A plurality of panels 80 is attached to and extends between the side members 78. Each of the panels 80 is attached to a lower side 82 of a respective one of the side members 78.

A plurality of support braces 84 may be removably attached to and extend between one of the first 36 and second 38 end frames and the base 12. The first end frame 36 has two of the support braces 84 attached thereto and the second end frame 38 has two of the support braces 84 attached thereto. The plurality of support braces 84 are removably attached to improve the rigidity of the first 36 and second 38 end frames by providing support between the first 36 and second 38 end frames and the base 12.

A plurality of storage straps 86 is configured to secure each of the first end frame 36, the second end frame 38, and the middle shelf 72 together when each is removed from the base 12. A plurality of the storage straps 86 is configured to secure each of the support braces 84 to the base 12 when removed from the base 12, such as when the collapsible bag cart 10 is not in use. The storage straps 86 may be of various lengths or securing methods sufficient to secure the parts and withstand the forces incurred during transportation.

In use, the components of the collapsible bag cart 10 are assembled and removably fastened. Once assembled the collapsible bag cart 10 is mobile and structurally ready to be pushed around during shopping and loaded with shopping goods. Shopping bags with handles may be hung from the bag hanging mounts 60 and shopping bags or goods without handles may be placed on the middle shelf 72 and base 12. The collapsible bag cart 10 may be maneuvered around by the push handle 68 and transport handle 70 during shopping and transportation. The middle shelf 72, second end frame 38, and hanger shelf 52 may be absent in alternative embodiments of the collapsible bag cart 10 to allow for moving items not requiring the fully assembled embodiment.

When not in use, the components of the collapsible bag cart 10 can be disassembled into their individual components for storage. The individual components are then secured to each other in two groups for storage. During storage the components are secured together to minimize the required space and allow for transport. The support braces 84 are secured to the top of the planks 32 of the base 12 using the storage straps 86. These assembled components may be rolled around during transport and storage. The middle shelf 72 and first end frame 36 may be secured to opposing surfaces of the second end frame 38 using the storage straps 86. The transport handle 70 should be orientated to extend upward from the secured components and the push handle 68 orientated to project away from the second end frame 38. The hanger shelf 52 is removably fastened to the previously secured first end frame 36. The hanger shelf 52 is orientated so the bag hanging mounts 60 project inward toward the second end frame 38 during transport. These assembled components may be carried around by the transportation handle 70 during transport and storage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shopping bag cart assembly comprising:
a base having a front end and a rear end;
a plurality of wheels being rotatably coupled to and extending downwardly from said base;
a first end frame being removably attached to and extending upwardly from said rear end of said base, a second end frame being removably attached to and extending upwardly from said front end of said base;
a hanger shelf being removably attached to and extending between said first and second end frames, said hanger shelf being positioned adjacent to an apex of each of said first and second end frame; and
a plurality of bag hanging mounts being attached to and extending upwardly from said hanger shelf.

2. The shopping bag cart assembly according to claim 1, wherein said base comprises:
a pair of longitudinal members each having a first end, a second end, a bottom side and a top side, and an interior face wherein said interior faces of said longitudinal members face each other, said first ends corresponding to said rear end;
a plurality of cross members each being attached to and extending between said interior faces of said longitudinal members, one of said cross members being positioned adjacent to said first ends and one of said cross members being positioned adjacent to said second ends; and
a plurality of planks being attached to and extending between said longitudinal members, each of said planks being attached to said bottom sides of said longitudinal members.

3. The shopping bag cart assembly according to claim 2, wherein said planks are spaced from each other a distance of between 0.5 inches and 3.0 inches.

4. The shopping bag cart assembly according to claim 1, wherein said first and second end frames each comprise:
a pair of vertical members each having a height between 3.0 and 6.0 feet;
a plurality of cross-beams extending between and being attached to said vertical members, said cross-beams including a bottom cross-beam, a middle cross-beam and a top cross-beam; and
said top cross-beam having a pair of spaced receivers extending therein.

5. The shopping bag cart assembly according to claim 4, wherein said hanger shelf includes:
a pair of support beams each having a pair of free ends, each of said receivers being configured to removably receive one of said free ends;
at least one brace extending between and being attached to said support beams;
each of said support beams having at least five of said bag hanging mounts attached thereto.

6. The shopping bag cart assembly according to claim 5, wherein said bag hanging mounts being spaced from each other and extending upwardly from a corresponding one of said support beams, each of said bag hanging mounts including a pair of legs and central member being attached to and extending between said legs, each of said central members having a top surface having convexly arcuate shape.

7. The shopping bag cart assembly according to claim 1, wherein said bag hanging mounts being spaced from each other and extending upwardly from a corresponding one of said support beams, each of said bag hanging mounts including a pair of legs and central member being attached to and extending between said legs, each of said central members having a top surface having convexly arcuate shape.

8. The shopping bag cart assembly according to claim 1, further including a push handle being attached to said first end frame.

9. The shopping bag cart assembly according to claim 4, further including a transport handle being attached to one of said vertical members of said second end frame, said transport handle extending laterally away from said second end frame.

10. The shopping bag cart assembly according to claim 8, further including a transport handle being attached to said second end frame, said transport handle extending laterally away from said second end frame.

11. The shopping bag cart assembly according to claim 1, further including a middle shelf being removably attached to and extending between said first and second end frames, said middle shelf being vertically disposed between said base and said hanger shelf.

12. The shopping bag cart assembly according to claim 4, further including a middle shelf being removably attached to and extending between said first and second end frames, said middle shelf being vertically disposed between said base and said hanger shelf.

13. The shopping bag cart assembly according to claim 12, said middle shelf comprising:
an outer frame having a pair of end members, each of said middle cross-beams being removably attached to one of said end members;
a pair of side members extending between and being attached to said end members; and
a plurality of panels being attached to and extending between said side members, each of said panels being attached to a lower side of a respective one of said side members.

14. The shopping bag cart assembly according to claim 1, further including a plurality of support braces being removably attached to and extending between one of said first and second end frames and said base, wherein said first end frame has two of said support braces attached thereto and said second end frame has two of said support braces attached thereto.

15. The shopping bag cart assembly according to claim 11, further including a plurality of storage straps configured to secure each of said first end frame, said second end frame, and said middle shelf together when each is removed from said base.

16. A shopping bag cart assembly comprising:
a base having a front end and a rear end, said base comprising:
a pair of longitudinal members each having a first end, a second end, a bottom side and a top side, and an interior face wherein said interior faces of said longitudinal members face each other, said first ends corresponding to said rear end;
a plurality of cross members each being attached to and extending between said interior faces of said longitudinal members, one of said cross members being positioned adjacent to said first ends and one of said cross members being positioned adjacent to said second ends;
a plurality of planks being attached to and extending between said longitudinal members, each of said planks being attached to said bottom sides of said longitudinal members, said planks being spaced from each other a distance of between 0.5 inches and 3.0 inches;
a plurality of wheels being rotatably coupled to and extending downwardly from said base;
a first end frame being removably attached to and extending upwardly from said rear end of said base, a second end frame being removably attached to and extending upwardly from said front end of said base, said first and second end frames each comprising:
a pair of vertical members each having a height between 3.0 and 6.0 feet;
a plurality of cross-beams extending between and being attached to said vertical members, said cross-beams including a bottom cross-beam, a middle cross-beam and a top cross-beam, said bottom cross-beam abutting said base;
said top cross-beam having a pair of spaced receivers extending therein;
a hanger shelf being removably attached to and extending between said first and second end frames, said hanger shelf being positioned adjacent to an apex of each of said first and second end frame, said hanger shelf including:
a pair of support beams each having a pair of free ends, each of said receivers being configured to removably receive one of said free ends;
at least one brace extending between and being attached to said support beams;
a plurality of bag hanging mounts, each of said support beams having at least five of said bag hanging mounts attached thereto, said bag hanging mounts being spaced from each other and extending upwardly from a corresponding one of said support beams, each of said bag hanging mounts including a pair of legs and central member being attached to and extending between said legs, each of said central members having a top surface having convexly arcuate shape;
a push handle being attached to said first end frame, said push handle being positioned adjacent to said top cross-beam and extending rearwardly therefrom;
a transport handle being attached to one of said vertical members of said second end frame, said transport handle extending laterally away from said second end frame;
a middle shelf being removably attached to and extending between said first and second end frames, said middle shelf being vertically disposed between said base and said hanger shelf, said middle shelf comprising:
an outer frame having a pair of end members, each of said middle cross-beams being removably attached to one of said end members;
a pair of side members extending between and being attached to said end members;
a plurality of panels being attached to and extending between said side members, each of said panels being attached to a lower side of a respective one of said side members;
a plurality of support braces being removably attached to and extending between one of said first and second end frames and said base, wherein said first end frame has two of said support braces attached thereto and said second end frame has two of said support braces attached thereto; and
a plurality of storage straps configured to secure each of said first end frame, said second end frame, and said middle shelf together when each is removed from said base.
